(19) United States
(12) Patent Application Publication
(10) Pub. No.: US 2019/0127927 A1
(43) Pub. Date: May 2, 2019

(54) ASPHALT FIBER METERING SYSTEM

(71) Applicant: Leonard Nakonechny, Winnipeg (CA)

(72) Inventor: Leonard Nakonechny, Winnipeg (CA)

(21) Appl. No.: 15/801,742

(22) Filed: Nov. 2, 2017

(51) Int. Cl. E01C 19/10; E01C 11/18; C04B 40/00; C04B 26/26; C04B 16/06

(52) U.S. Cl. CPC E01C 19/1027; E01C 11/18; C04B 16/0691; C04B 26/26; C04B 40/0032

(57) ABSTRACT

A system for metering reinforcing aramid fibers into an asphalt mixer includes a vertical feed chute with straight walls that spans substantially a full diameter and a full length of a horizontal feed auger to feed bulk fibrous material by gravity from the feed chute in a radial direction along the length of the feed auger. The feed auger is rotated at a controlled rate proportionally to the rate of production of an asphalt and mineral aggregate mixture. A pneumatic conveying line conveys the reinforcing fibers from an outlet end of the feed auger to an asphalt mixer for mixing with the asphalt and mineral aggregate to produce a fiber reinforced asphalt concrete with an accurately proportioned amount of fiber dispersed therein.

### FIELD OF THE INVENTION

The present invention relates to a metering system for metering reinforcing fibers, for example aramid fibers, into an asphalt production system.

### BACKGROUND

Kevlar fiber use in hot mix asphalt for road building is a relatively new process. Although Kevlar fiber is known to have desirable strength properties, for example having a tensile strength 5 times that of iron, there are problems in mixing of this product into the asphalt concrete (AC) hot mix. Firstly, the product is very difficult to work with because it is bulky, heat sensitive (having a wax-like coating on the fibers), does not flow readily, and has a tendency to bridge or clog within ducts or passages. Secondly, bulk fibrous material is difficult to meter accurately. A desirable rate of mixing is 4.6 ounces of fiber for each tonne of AC hot mix.

One known supplier of Kevlar fiber for use in asphalt concrete is ACE Fiber in Dayton, Ohio, United States. ACE Fiber uses a manual metering system. It is a two-person operation. One person weighs a sample of fiber. The second person uses a forced air Venturi to suck up and blow the fiber into the AC hot mix plant at a specified length of time. This process has to correlate to the rate of production of the AC hot mix. Another fiber company “Fortified Fiber” puts their product into bags. For metering purposes, a person throws these bags into a AC hot mix plant at specified intervals. Both of these processes have to be manually correlated to the plant production.

### SUMMARY OF THE INVENTION

According to one aspect of the invention there is provided a method of preparing an asphalt concrete reinforced with reinforcing fibers, the method comprising:

providing a fiber metering system including a feed auger, a feed auger housing at least partially surrounding the feed auger from an inlet end to an outlet end of the feed auger, and a feed chute in communication with the feed auger housing;

loading the feed chute with the reinforcing fibers;

rotating the feed auger relative to the feed auger housing such that (i) the reinforcing fibers are conveyed longitudinally of the feed auger to the outlet end of the feed auger and (ii) the reinforcing fibers are fed by gravity from the feed chute radially of the feed auger into the feed auger housing in proximity to the inlet end; and

combining the reinforcing fibers dispensed from the outlet end of the feed auger with asphalt and mineral aggregate to produce the asphalt concrete.

The reinforcing fibers preferably consist of aramid fibers.

The method may further include pneumatically conveying the reinforcing fibers from the outlet end of the feed auger to an asphalt mixer and combining the reinforcing fibers with the asphalt and the mineral aggregate at the asphalt mixer.

Preferably a speed of rotation of the feed auger is varied to vary a rate of fiber delivery to be combined with the asphalt and the mineral aggregate.

When dispensing the mineral aggregate and the asphalt into an asphalt mixer at a controlled rate, the method may further include setting a speed of rotation of the feed auger proportionally to said controlled rate.

According to a second aspect of the present invention there is provided a fiber metering system for metering reinforcing fibers into an asphalt mixer, the system comprising:

a feed auger assembly including a feed auger and a feed auger housing at least partially surrounding the feed auger to extend longitudinal of the feed auger from an inlet end to an outlet end of the feed auger assembly, the feed auger being rotatable relative to the feed auger housing about an auger axis of the feed auger so as to convey the reinforcing fibers longitudinal of the feed auger towards the outlet end of the feed auger assembly;

a feed chute extending along a chute axis from an inlet end having an opening for receiving the reinforcing fibers therein to an outlet end in communication with the feed auger housing for delivering the reinforcing fibers to the feed auger assembly, the chute axis being oriented radially of the auger axis and extending upwardly from the feed auger assembly from the outlet end to the inlet end thereof; and

a pneumatic conveying line for conveying the reinforcing fibers from the feed auger to the asphalt mixer, the pneumatic conveying line including a flow restrictor arranged to produce a suction in communication with the outlet end of the feed auger assembly for collecting the reinforcing fibers conveyed to the outlet end of the feed auger assembly into the pneumatic conveying line.

The reinforcing fibers preferably consist of aramid fibers.

The metering system according to the present invention advantageously permits feeding of aramid fibers into an asphalt mix in an accurate manner, while minimizing problems associated with clogging and bridging of the wax-like coated fibers. This metering system has done 17,000 tonnes of AC hot mix with an accuracy of 99.9%. This accuracy is very important because the fiber cost is $2.00 per oz. The fiber also has to be very consistent mix in the asphalt.

The metering system itself includes a screw installed in a round chamber. The screw is totally exposed in the holding chamber across a full diameter and along substantially a full length of the flighting of the screw. The feed chute above acts as holding chamber and preferably has walls which are perpendicular to the horizontal feed auger axis to prevent bridging. The speed reducer gearbox(es) rotate the screw and receive input from an electric motor. The electric motor which powers the screw is speed controlled by a variable frequency drive. The frequency drive can be controlled by the operator or it can be linked to the AC plant control which will correlate the meter speed to the production of asphalt.

When the feed chute comprises a pair of side walls in proximity to the outlet end of the feed chute, preferably the side walls are (i) spaced apart at opposing sides of the chute, (ii) parallel to one another, and (iii) parallel to the auger axis. More preferably, the side walls are spaced apart by a distance which is greater than a diameter of the feed auger.

When the feed chute includes boundary walls in proximity to the outlet end of the feed chute which extend about a full circumference about the chute axis of the feed chute, the boundary walls are preferably all oriented parallel to the chute axis.

When the feed chute comprises a pair of end walls in proximity to the outlet end of the feed chute, the end walls are preferably (i) spaced apart at opposing sides of the chute, (ii) parallel to one another, (iii) perpendicular to the auger axis, and (iv) spaced apart by a distance which spans a majority of a length of the feed auger.

When the feed auger housing includes a bottom wall which is semi-circular in shape about the feed auger, preferably a diameter of the bottom wall is greater than a diameter of the feed auger to define a radial space between the feed auger and the bottom wall. The radial space may be greater than ¼ of an inch and more preferably is approximately ½ of an inch. Accordingly, the diameter of the feed auger is preferably less than 80% of a diameter of the bottom wall, when using an auger having a diameter of three inches for example.

The system may further comprise a lid which is movable relative to the inlet end of the feed chute from an open position in which the inlet end of the feed chute is substantially unobstructed by the lid and a closed position in which the lid seals the inlet end of the feed chute closed in an air-tight manner.

The feed chute may further comprise a hopper connected to the inlet end of the feed chute having hopper walls which taper inwardly towards one another into the inlet end of the feed chute.

A variable speed drive may be operatively connected to the feed auger for driving rotation of the feed auger at a selected drive speed within a range of drive speeds.

When used in combination with an asphalt process controller which controls dispensing of the mineral aggregate and the asphalt into the asphalt mixer at a controlled rate, the variable speed drive may be operatively connected to the asphalt process controller so as to operate the feed auger at a speed of rotation which is proportional to said controlled rate.

### BRIEF DESCRIPTION OF THE DRAWINGS

One embodiment of the invention will now be described in conjunction with the accompanying drawings in which:

FIG. 1 is a schematic representation of the fiber metering system according to the present invention in combination with an asphalt production system;

FIG. 2 is a perspective view of the components of the fiber metering system;

FIG. 3 is a sectional view along the line 3-3 of FIG. 2; and

FIG. 4 is a sectional view along the line 4-4 in FIG. 3.

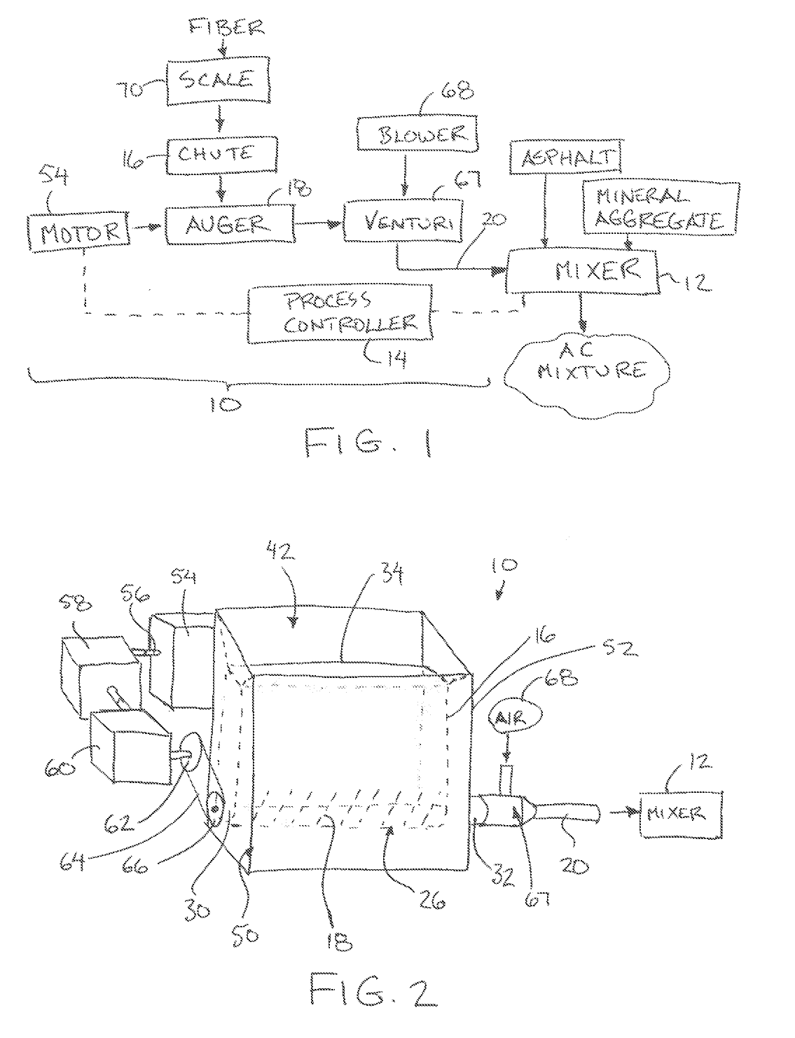

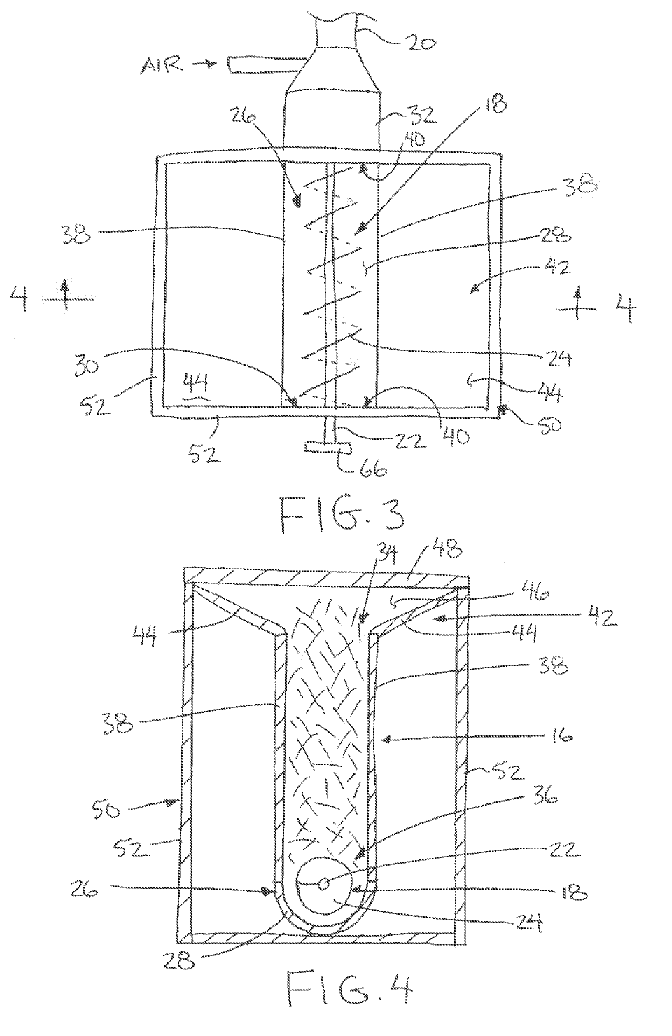

In the drawings like characters of reference indicate corresponding parts in the different figures.

### DETAILED DESCRIPTION

Referring to the accompanying figures, there is illustrated a fiber metering system generally indicated by reference numeral 10. The system 10 is intended for use with an asphalt concrete production system to produce a mix of asphalt, mineral aggregate, and fiber. The system is particularly suited for use in metering aramid fibers, and more particularly aramid fibers manufactured under the trademark Kevlar.

Asphalt concrete may be produced in batches or as a continuous process by feeding mineral aggregate and hot asphalt into a mixer 12. The asphalt concrete system typically includes a process controller 14 which controls the delivery rate of asphalt and mineral aggregate into the mixer which in turn controls the production rate of the asphalt concrete mixture.

The fiber metering system 10 generally includes a feed chute 16 functioning as a holding chamber for receiving bulk fibers therein, and a feed auger 18 for conveying the fibers from the feed chute 16 to a pneumatic conveying line 20 which pneumatically conveys the fibers from the metering system to the mixer 12 where the fibers are blown into the asphalt mixture for evenly distributing the fibers into the mixture.

The feed auger 18 includes an auger shaft 22 and the flighting 24 formed as a helical screw about the shaft and having a prescribed outer diameter which is constant along the length of the auger. The auger is received within an auger housing 26 which at least partially surrounds the feed auger. The feed chute 16 is positioned in proximity to the auger to span a majority of the length of the auger and a portion of the circumference about the auger such that the feed chute and the auger housing 26 connected to the feed chute collectively fully surround the feed auger. The auger housing includes a semi-circular wall 18 forming a generally U-shaped trough which spans the full length of the feed auger along the bottom side thereof such that the top half of the auger remains open to the feed chute 16 thereabove substantially across the full diameter or full width of the trough as well as substantially along the full length of the trough.

In a preferred embodiment, the auger has an outer diameter of approximately 3 inches while the radius of the semicircular wall 28 is two inches to define a trough width or trough diameter of approximately 4 inches. In this manner, there remains a radial gap between the outer circumference of the flighting of the feed auger and the inner surface of the semicircular wall 28 forming the bottom wall of the auger housing, in which the radial gap is approximately half an inch. In this manner, the radial gap occupies approximately 25% of the overall radius of the auger housing about the feed auger.

The bottom wall 28 of the auger housing is enclosed by an inlet end wall 30 spanning perpendicularly to the feed auger axis to fully enclose the inlet end of the feed auger. An opening is provided in the inlet end wall to receive a bearing therein which receives the end of the shaft 22 of the auger extending axially therethrough to support the feed auger rotatably about the feed auger axis thereof relative to the surrounding auger housing.

An outlet tube 32 surrounds the outlet end of the feed auger having a diameter equal to the trough diameter and which defines a passage therethrough communicating to the exterior of the auger housing. The helical flighting 24 is oriented relative to rotation of the feed auger such that rotation of the feed auger in operation conveys fibrous material within the auger housing longitudinally along the axis of the feed auger to be dispensed from the auger housing through the opening defined by the outlet tube 32.

The feed chute 16 defines a passage extending from an inlet 34 at a top end to an outlet 36 at a bottom end, in which the passage has a rectangular shaped cross section along the full length thereof. More particularly the rectangular cross-section of the feed chute 16 is defined by two parallel and opposed side walls 38 at laterally opposing sides of the feed auger axis, and two end walls 40 oriented perpendicularly to the feed auger axis and which are connected between the two side walls 38 in proximity to axially opposing ends of the feed auger. All of the walls 38 and 40 collectively define boundary walls extending about a full circumference of the passage of the feed chute in which all walls are oriented parallel to a longitudinal chute axis which extends vertically upward from the outlet to the inlet of the chute. The chute axis thus extends radially outward from the feed auger axis.

The two side walls 38 are formed continuously with opposing sides of the semicircular bottom wall 28 along the full length of the feed auger such that the side walls 38 are parallel to one another and the feed auger axis while also being spaced apart from one another by a distance which corresponds to the diameter of the bottom wall 28.

One of the end walls 40 at the inlet end of the auger is coplanar with the inner end wall 30 of the auger housing to be oriented perpendicularly to the feed auger axis. The opposing end wall lies in a common plane with the inlet opening of the outlet tube 32 of the axially opposing end of the feed auger such that the two end walls 40 are spaced apart by a distance corresponding approximately to an axial length of the flighting 24 of the feed auger.

The feed chute 16 height extends axially a length in a direction radial to the feed auger which is greater than the width of the feed chute in the longitudinal direction of the feed auger and greater than the width of the chute in the lateral direction corresponding to the diameter of the feed auger for maximizing the volume of fibrous material which can be stored within the holding chamber formed by the feed chute. For example, the feed chute may have a height which is double the elongate width of the feed chute in the direction of the feed auger axis.

A feed hopper 42 is connected to the inlet opening at the top end of the feed chute. The hopper portion 42 comprises two sloped walls 44 connected to the top edges of the two side walls 38 to span the full length of the side walls in the axial direction of the feed auger. The sloped walls 44 extend upwardly at a laterally outward slope away from one another to form a tapered mouth extending upwardly and outwardly from the inlet at the top end of the feed chute. A pair of end walls 46 which are coplanar with the respective end walls 40 and which are triangular in shape enclose axially opposing ends of the hopper 42 between the two sloped walls 44. The top edges of the end walls 40 and the sloped walls 42 lie in a common horizontal plane defining an open top end of the hopper portion lying perpendicular to the chute axis. In this manner, bulk fibers can be readily loaded into the open top end of the hopper for being guided into the inlet end of the feed chute.

A lid 48 is pivotally coupled along one edge of the perimeter opening of the hopper for pivotal movement of the lid between an open position in which the open top end of the hopper is substantially unobstructed by the lid for loading bulk fibers therein, and a closed position in which the lid spans across the open top end of the hopper portion in an airtight sealed relationship therewith. In this manner the hopper and the inlet end of the feed chute are sealed closed in an airtight manner.

A supporting casing 50 is formed by four supporting walls 52 which are vertically oriented about a rectangular perimeter of the top opening of the hopper 42. The walls 52 of the casing extend vertically downward from the hopper to span the full combined height of the auger housing 26, the feed chute thereabove, and the hopper thereabove. The bottom of the walls 52 of the casing 54 form a base suitable for being supported on a horizontal supporting surface. The inlet end of the shaft 22 of the feed auger protrudes through one of the walls 52 of the supporting casing at one side thereof, while the outlet tube 32 protrudes through the opposing wall 52 at the other side of the casing.

An auger drive system is operatively connected to the end of the feed auger shaft protruding outwardly from the supporting casing 50. The drive system includes an electric motor 54 operable at different rates of rotation according to a variable frequency drive. A rotary output 56 of the motor 54 is connected to the input of a first gearbox 58 functioning as a speed reducer to reduce the rate of rotation from an input shaft to an output shaft thereof. The input shaft is coupled to rotate with the rotary output 56 of the motor whereas the outlet shaft is coupled to rotate with the corresponding inlet shaft of a second gearbox 60 also functioning as a speed reducer from the inlet shaft to the outlet shaft thereof. The outlet shaft of the second gearbox 60 supports a drive gear 62 thereon which is coupled by a suitable drive chain 64 to a driven gear 66 mounted on the inlet end of the auger shaft. In this manner, activation of the motor initially rotates the rotary output shaft 56 of the motor at a prescribed rotation speed. This rotation is communicated through the first and second gearbox is to reduce the speed thereof for rotating the drive gear at a reduced rate of rotation which in turn transfers this rotation to the driven gear 66 through the drive chain 64. The auger rotates with the driven gear 66 for rotating the flighting 24 which conveys the fibrous material to the outlet end of the feed auger.

In operation, the fibrous material loaded into the feed chute through the hopper when the lid is open falls by gravity through the feed chute to be in turn fed radially into the feed auger substantially along the full length of the feed auger. Rotation of the feed auger guides material within the auger housing towards the outlet end, while simultaneously enabling fibers within the feed chute to fall by gravity into the feed auger for replenishing the content of fibers within the feed auger housing.

The pneumatic conveying line 20 of the system is operatively connected between the outlet end of the feed auger and the mixer of the asphalt production system. The pneumatic conveying line incorporates a Venturi nozzle 66 therein in which a high-pressure flow is fed from a source 68, for example a blower, into the Venturi nozzle to create a low-pressure suction in communication with the outlet end of the outlet tube 32 of the feed auger housing. The airflow from the nozzle thus picks up the fibers from the outlet tube 32 of the feed auger housing by suction and carries the fibers pneumatically by the flow of air through the pneumatic conveying line to the mixer. A suitable nozzle at the outlet end of the pneumatic conveying line evenly disburses the pneumatically conveyed fibers evenly over a larger area within the mixer.

A weigh scale 70 is associated with the system 10 so that an operator may initially load the feed chute by weighing a portioned amount of aramid fibers and then loading this portion amount into the feed chute with the assistance of the hopper. Once the portioned amount of fibers is loaded in the feed chute, the lid can be closed for sealing the feed chute. In operation, the user activates the blower to initiate a pneumatic flow of air through the pneumatic conveying line. The asphalt process controller which controls the rate of delivery of asphalt and mineral aggregate into the mixer, determines the corresponding rate of delivery of fibers which would result in a proper proportioned mix of fibers, asphalt and mineral aggregate. The asphalt process controller then sends instructions to the motor to control the rate of rotation of the motor 54 to operate the screw to meter fibers from the feed chute into the outlet tube of the auger housing at the corresponding rate which is determined to produce a proper proportioned mix. The pneumatic conveying line continues to draw any fibers conveyed by the auger into the outlet tube into the pneumatic conveying line for subsequent dispersal into the asphalt mixture. The rate of operation of the auger can be adjusted in real-time according to the production rate of asphalt as determined by the mixer.

Alternatively, when producing asphalt concrete in batches, the asphalt process controller determines the desired amount of fibers to be added to the batch mixture of asphalt and mineral aggregate and then controls the motor to dispense this desired amount. In this instance the feed auger may be operated at a constant rate of rotation, with the controller simply turning the rotation on and off so that the duration that the feed auger is actively rotating determines the overall amount of fibers dispensed by the feed auger into the pneumatic conveying line.

As the content of fibers within the feed chute is consumed, the auger and blower may be turned off and another measured amount of fibers can be loaded into the feed chute once the lid is opened.

The system 10 described herein is particularly advantageous over convention metering systems for metering fibrous material by the structure of the walls of the feed chute which are arranged so that the feed chute passage is vertical to avoid bridging and the size of the feed chute to span substantially the full length and diameter of the feed auger to assist in loading the feed auger radially with fibers from the feed chute by gravity. The radial space between the diameter of the auger and the diameter of the semicircular bottom wall also assists in optimal conveyance of the fibers along the length of the auger housing without plugging or damage to the fibers between the peripheral edge of the feed auger and the surrounding housing.

Since various modifications can be made in my invention as herein above described, and many apparently widely different embodiments of same made, it is intended that all matter contained in the accompanying specification shall be interpreted as illustrative only and not in a limiting sense.

1.-5. (canceled)

6. A fiber metering system for metering reinforcing fibers into an asphalt mixer, the system comprising:
a feed auger assembly including a feed auger and a feed auger housing at least partially surrounding the feed auger to extend longitudinal of the feed auger from an inlet end to an outlet end of the feed auger assembly, the feed auger being rotatable relative to the feed auger housing about an auger axis of the feed auger so as to convey the reinforcing fibers longitudinal of the feed auger towards the outlet end of the feed auger assembly;
a feed chute extending along a chute axis from an inlet end having an opening for receiving the reinforcing fibers therein to an outlet end in communication with the feed auger housing for delivering the reinforcing fibers to the feed auger assembly, the chute axis being oriented radially of the auger axis and extending upwardly from the feed auger assembly from the outlet end to the inlet end thereof; and
a pneumatic conveying line for conveying the reinforcing fibers from the feed auger to the asphalt mixer, the pneumatic conveying line including a flow restrictor arranged to produce a suction in communication with the outlet end of the feed auger assembly for collecting the reinforcing fibers conveyed to the outlet end of the feed auger assembly into the pneumatic conveying line.

7. The system according to claim 6 in combination with the reinforcing fibers, wherein the reinforcing fibers consist of aramid fibers.

8. The system according to claim 6 wherein the feed chute comprises a pair of side walls in proximity to the outlet end of the feed chute which are (i) spaced apart at opposing sides of the chute, (ii) parallel to one another, and (iii) parallel to the auger axis.

9. The system according to claim 8 wherein the side walls are spaced apart by a distance which is greater than a diameter of the feed auger.

10. The system according to claim 6 wherein the feed chute includes boundary walls in proximity to the outlet end of the feed chute which extend about a full circumference about the chute axis of the feed chute, the boundary walls all being oriented parallel to the chute axis.

11. The system according to claim 6 wherein the feed chute comprises a pair of end walls in proximity to the outlet end of the feed chute which are (i) spaced apart at opposing sides of the chute, (ii) parallel to one another, (iii) perpendicular to the auger axis, and (iv) spaced apart by a distance which spans a majority of a length of the feed auger.

12. The system according to claim 6 wherein the feed auger housing includes a bottom wall which is semi-circular in shape about the feed auger, a diameter of the bottom wall being greater than a diameter of the feed auger to define a radial space between the feed auger and the bottom wall.

13. The system according to claim 12 wherein the radial space is greater than ¼ of an inch.

14. The system according to claim 12 wherein the radial space is approximately ½ of an inch.

15. The system according to claim 12 wherein the diameter of the feed auger is less than 80% of a diameter of the bottom wall.

16. The system according to claim 6 further comprising a lid which is movable relative to the inlet end of the feed chute from an open position in which the inlet end of the feed chute is substantially unobstructed by the lid and a closed position in which the lid seals the inlet end of the feed chute closed in an air-tight manner.

17. The system according to claim 6 further comprising a hopper connected to the inlet end of the feed chute having hopper walls which taper inwardly towards one another into the inlet end of the feed chute.

18. The system according to claim 6 further comprising a variable speed drive operatively connected to the feed auger for driving rotation of the feed auger at a selected drive speed within a range of drive speeds.

19. The system according to claim 18 in combination with an asphalt process controller which controls dispensing of the mineral aggregate and the asphalt into the asphalt mixer at a controlled rate, wherein the variable speed drive is operatively connected to the asphalt process controller so as to operate the feed auger at a speed of rotation which is proportional to said controlled rate.
